(19) United States
(12) Patent Application Publication
(10) Pub. No.: US 2025/0126515 A1
(43) Pub. Date: Apr. 17, 2025

(54) Pre-caching content using network capacity and other metrics

(71) Applicant: T-MOBILE INNOVATIONS LLC, Overland Park, KS (US)

(72) Inventors: Herkole SAVA, Centreville, VA (US); Michael Scott WITHERELL, Portland, OR (US); Ankit Arvind MUCHHALA, Leesburg, VA (US)

(21) Appl. No.: 18/380,988

(22) Filed: Oct. 17, 2023

(51) Int. Cl. H04W 28/02; H04W 28/14

(52) U.S. Cl. CPC H04W 28/0289; H04W 28/0236; H04W 28/14

(57) ABSTRACT

Systems and methods are provided for pre-caching content to customer premises equipment (CPE) such as set-top boxes, fixed wireless access devices, etc. Video streaming services are increasingly popular and can put a strain on network resources during peak hours. Wireless network peak hour capacity demand can be reduced by utilizing off-peak hour content/video caching. A cache time during off-peak hours can be determined through the interaction of wireless network and content provider servers.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

In aspects set forth herein, systems and methods are provided for intelligently caching content. More particularly, in aspects set forth herein, systems and methods enable intelligently caching content. Video streaming services are increasingly popular and can put a strain on network resources during peak hours. Wireless network peak hour capacity demand can be reduced by utilizing off-peak hour content/video caching. A cache time during off-peak hours can be determined through the interaction of wireless network and content provider servers.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary network environment in which implementations of the present disclosure may be employed, in accordance with aspects herein;

FIG. 2 depicts a diagram of an exemplary content cache call flow in which implementations of the present disclosure may be employed, in accordance with aspects herein;

FIG. 3 depicts a flow diagram of a method for intelligently caching content, in accordance with aspects herein;

FIG. 4 depicts a flow diagram of a method for intelligently caching content, in accordance with aspects herein;

FIG. 5 depicts a flow diagram of a method for intelligently caching content, in accordance with aspects herein; and

FIG. 6 depicts a diagram of an exemplary computing environment suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
APN Access Point Name
CD-ROM Compact Disk Read Only Memory
CDMA Code Division Multiple Access
CPE Customer Premises Equipment
eNodeB Evolved Node B
GIS Geographic/Geographical/Geospatial Information System
gNodeB Next Generation Node B
GPRS General Packet Radio Service
GSM Global System for Mobile communications
iDEN Integrated Digital Enhanced Network
DVD Digital Versatile Discs
EEPROM Electrically Erasable Programmable Read Only Memory
LED Light Emitting Diode
LTE Long Term Evolution
MIMO Multiple Input Multiple Output
MD Mobile Device
PC Personal Computer
PCS Personal Communications Service
PDA Personal Digital Assistant
RAM Random Access Memory
RET Remote Electrical Tilt
RF Radio-Frequency
RFI Radio-Frequency Interference
R/N Relay Node
ROM Read Only Memory
SINR Transmission-to-Interference-Plus-Noise Ratio
SMF Session Management Function
SNR Transmission-to-noise ratio
SON Self-Organizing Networks
TDMA Time Division Multiple Access
TXRU Transceiver (or Transceiver Unit)
UE User Equipment

Further, various technical terms are used throughout this description. An illustrative resource that fleshes out various aspects of these terms can be found in Newton's Telecom Dictionary, 32d Edition (2022).

As used herein, the term “node” is used to refer to network access technology for the provision of wireless telecommunication services from a base station to one or more electronic devices, such as an eNodeB, gNodeB, etc.

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules-in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, a traditional telecommunications network employs a plurality of base stations (i.e., cell sites, cell towers) to provide network coverage. The base stations are employed to broadcast and transmit transmissions to user devices of the telecommunications network. An access point may be considered to be a portion of a base station that may comprise an antenna, a radio, and/or a controller.

As employed herein, a UE (also referenced herein as a user device) or WCD can include any device employed by an end-user to communicate with a wireless telecommunications network. A UE can include a mobile device, a mobile broadband adapter, or any other communications device employed to communicate with the wireless telecommunications network. A UE, as one of ordinary skill in the art may appreciate, generally includes one or more antenna coupled to a radio for exchanging (e.g., transmitting and receiving) transmissions with a nearby base station.

In conventional cellular communications technology, a 5G telecommunications network comprises a 5G Core Network (5GC) and a gNB. The 5GC architecture, as known to those in the art, relies on a Service-Based Architecture (SBA) framework where the architecture elements are defined in terms of Network Functions (NF) rather than by traditional network entities. Using interfaces of a common framework, any NF can offer its services to other NFs that are permitted to make use of their functions. At times, the network interfaces can experience complete failures, degradations, and the like. This compromises the ability of other NFs to obtain necessary data to establish reliable sessions for UEs.

The present disclosure is directed to intelligently caching content. Video streaming services are increasingly popular and can put a strain on network resources during peak hours. Wireless network peak hour capacity demand can be reduced by utilizing off-peak hour content/video caching. A window of time for pre-caching content during off-peak hours can be determined through the interaction of wireless network and content provider servers.

Accordingly, a first aspect of the present disclosure is directed to a system for intelligently caching content. The system comprises one or more processors and one or more computer-readable media storing computer-usable instructions that, when executed by the one or more processors, cause the one or more processors to: predict an upcoming time period of congestion for a cell site associated with a first device; identify a window of time for pre-cache of content outside of the upcoming time period of congestion, wherein identifying the window of time for pre-cache of content includes: identifying a storage capacity of the first device and identifying a system capacity for the cell site; and communicate instructions to download the content, wherein the instructions include the window of time to download the content.

A second aspect of the present disclosure is directed to a method for intelligently caching content. The method comprises predicting an upcoming time period of congestion for a cell site associated with a first device; identifying a window of time for pre-cache of content outside of the upcoming time period of congestion, wherein identifying the window of time for pre-cache of content includes: identifying a storage capacity of the first device; and identifying a system capacity for the cell site; and communicating instructions to download the content, wherein the instructions include the window of time to download the content.

Another aspect of the present disclosure is directed to a system for intelligently caching content. The system comprises one or more processors; and one or more computer-readable media storing computer-usable instructions that, when executed by the one or more processors, cause the one or more processors to: receive a device registration for a first device, wherein the device registration includes an IP address of the first device, a location of the first device, a storage capacity of the first device, and a window of time available to pre-cache to the first device, wherein the window of time available to pre-cache to the first device is based on network system capacity for a cell site associated with the first device; receive an application request from a second device associated with the first device, where the application request includes at least a location of the second device; map the first device to any device having a same location as the first device, including the second device having established connectivity to a content server through the first device; download content for pre-caching locally at the first device during the window of time available for pre-caching content; receive a request for the content from the second device; and provide a local URL to the second device to access content locally at the first device.

As previously stated, video streaming services are increasingly popular and can put a strain on network resources during peak hours. Often times, during peak hours, users are performing the same tasks as many other users, such as requesting videos or other digital content for playback on their devices (e.g., watching content streaming services). This puts incredible demand on wireless networks to be able to deliver the data for a satisfactory user experience (e.g., high resolution content) and creates congestion on the network. Efforts to reduce demands have been explored, but there is a current disconnect between the caching of content and wireless network resources. The present disclosure seeks to reduce wireless network peak hour capacity demand by utilizing off-peak hour content/video caching. This can be achieved by predicting off-peak hours and specific parameters for downloading content during off-peak hours, thereby shifting traffic to a higher capacity time frame.

Not all content can be shifted to off-peak hours though, so the problem is not easily solved by simply switching cache actions to off-peak times because off-peak downloads still require network resources. Practically speaking, there is a balance between shifting traffic to off-peak hour downloads and continuing to provide a real-time content retrieval that is based on costs to the wireless network. The present disclosure utilizes a prediction accuracy rate to identify a predetermined threshold which is met in order to perform pre-cache of content. If the prediction accuracy rate predetermined threshold is not met, a pre-cache download of content is not performed for the specific user. If the prediction accuracy rate predetermined threshold is met, a pre-cache download of content is performed for the specific user. Various other wireless network metrics are evaluated when determining (i) whether to pre-cache content and (ii) when to pre-cache content, and are discussed herein.

The present discussion allows for the interaction of a content provider server with a wireless network server. As part of the wireless network, a customer premises equipment (CPE) device is referred to herein as the source of the local storage. In embodiments, the CPE is a fixed wireless access (FWA) device. However, the CPE may not be necessary in some aspects and the user device requesting the content (e.g., a smartphone, a tablet, a television, etc.) can directly communicate with the wireless network and locally store data on the device itself. Additionally, in other aspects, while we are primarily discussing terrestrial networks herein, the present disclosure applies to satellites as well, such that a satellite of a radio access network could be communicating with a content server. Satellite delivery of content becomes congested incredibly fast and the present disclosure has high applicability to this technology area.

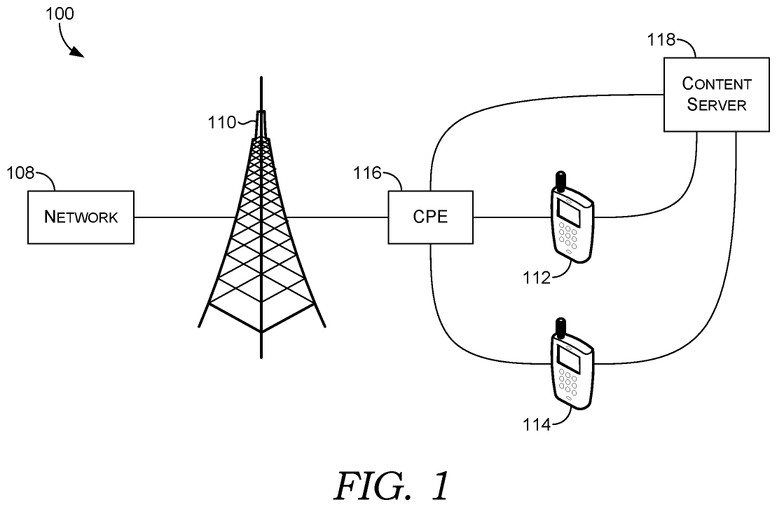

Turning to FIG. 1, a network environment suitable for use in implementing embodiments of the present disclosure is provided. Such a network environment is illustrated and designated generally as network environment 100. Network environment 100 is but one example of a suitable network environment and is not intended to suggest any limitation as to the scope of use or functionality of the disclosure. Neither should the network environment 100 be interpreted as having any dependency or requirement relating to any one or combination of components illustrated.

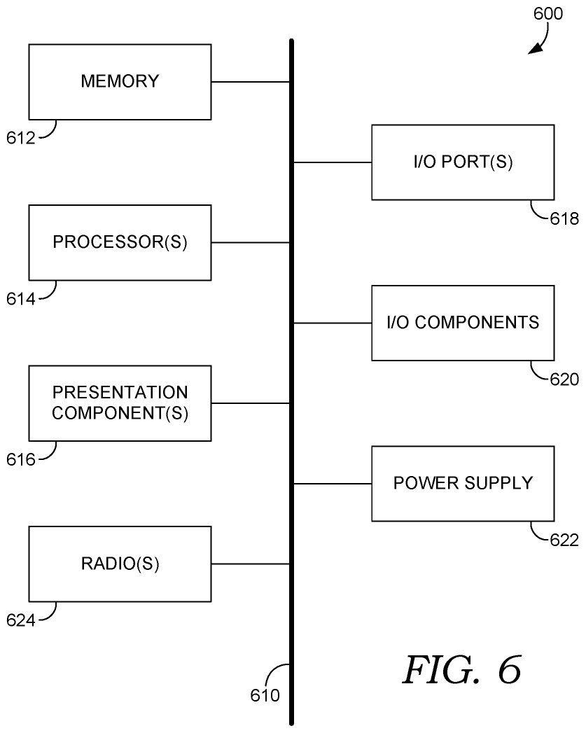

A network cell may comprise a base station to facilitate wireless communication between a communications device within the network cell, such as communications device 600 described with respect to FIG. 6, and a network. As shown in FIG. 1, communications device may be UE 112 or UE 114. In the network environment 100, UE 112 and UE 114 may communicate with other devices, such as mobile devices, servers, etc. The 112 and UE 114 may take on a variety of forms, such as a personal computer, a laptop computer, a tablet, a netbook, a mobile phone, a Smart phone, a personal digital assistant, a television, or any other device capable of communicating with other devices. For example, the 112 and UE 114 may take on any form such as, for example, a mobile device or any other computing device capable of wirelessly communication with the other devices using a network. Makers of illustrative devices include, for example, Research in Motion, Creative Technologies Corp., Samsung, Apple Computer, and the like. A device can include, for example, a display(s), a power source(s) (e.g., a battery), a data store(s), a speaker(s), memory, a buffer(s), and the like. In embodiments, 112 and UE 114 comprises a wireless or mobile device with which a wireless telecommunication network(s) can be utilized for communication (e.g., voice and/or data communication). In this regard, the 112 and UE 114 can be any computing device that communicates by way of, for example, a 5G network.

The 112 and UE 114 may utilize a network 108 to communicate with other computing devices (e.g., mobile device(s), a server(s), a personal computer(s), etc.). In embodiments, the network 108 is a telecommunications network, or a portion thereof. A telecommunications network might include an array of devices or components, some of which are not shown so as to not obscure more relevant aspects of the invention. Components such as terminals, links, and nodes (as well as other components) may provide connectivity in some embodiments. The network 108 may include multiple networks. The network 108 may be part of a telecommunications network that connects subscribers to their immediate service provider. In embodiments, the network 108 is associated with a telecommunications provider that provides services to user devices, such as 112 and UE 114. For example, the network 108 may provide voice services to user devices or corresponding users that are registered or subscribed to utilize the services provided by a telecommunications provider. A component of the network 108 is illustrated herein as base station/tower 110.

As shown in FIG. 1, the tower 110 communicates with one or more CPEs, such as CPE 116. The tower 110 also has direct communication to a plurality of user devices, but those connections are not illustrated below for simplicity. The CPE 116 communicates with at least UE 112 and UE 114 (and any other UE connected thereto), the tower 110, and the content server 118.

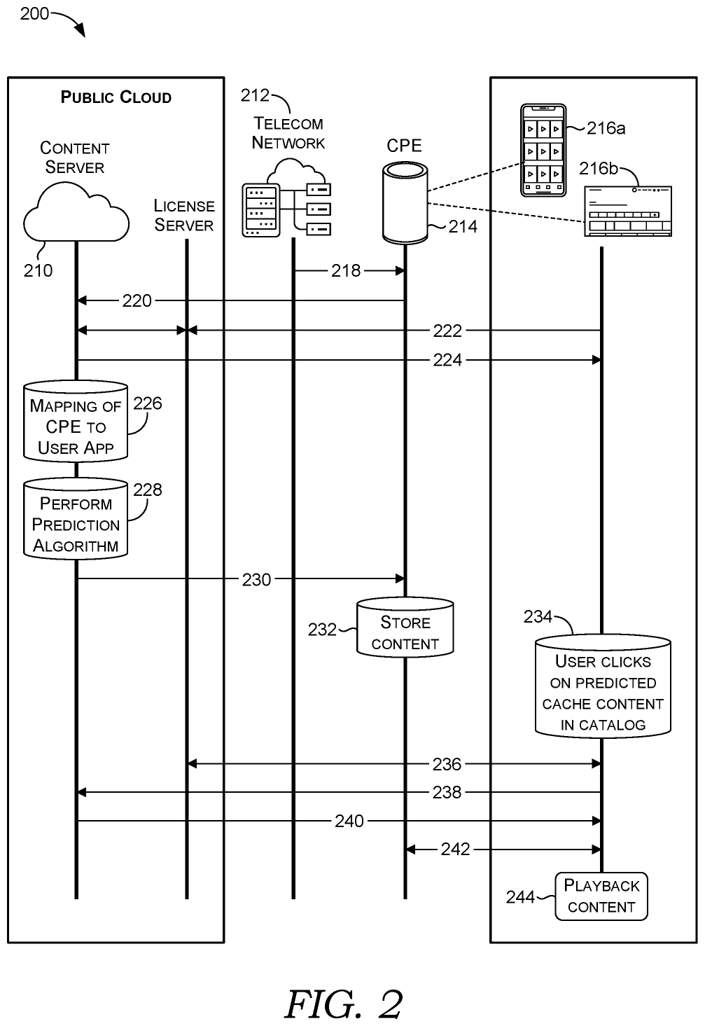

FIG. 2 provides an exemplary content cache call flow 200 to illustrate implementations of the present disclosure. As shown, a content server 210 (e.g., content service provider), a telecommunications network 212, a CPE 214, and one or more user devices 216aand 216b are in communication. Initially, step 218 illustrates providing a recommended time to pre-cache content to the CPE 214. The network 212 can predict a recommended time to pre-cache/window of time to pre-cache. In aspects, this may be performed at the user device-level via a content provider's application, leveraging data from both the content provider/server 210 and the network 212. The predicted time to cache can include a start time and a stop time when caching may occur. The predicted time to cache is outside of a period of congestion. The network 212, using historical information for a cell site, can predict a load on a cell site for a later time. Thus, if a particular cell site is heavily congested from 5 pm-11 pm each night, it can be predicted that the cell site will experience congestion tomorrow from 5 pm-11 pm. This prediction is unique to each cell site, as locations and markets vary. For example, a cell site that is downtown may have earlier peak hours due to a shorter commute time than a cell site in a rural area 45 minutes from the downtown area, which may have a peak time that begins an hour or two later than the downtown area. Additionally, user behaviors are different and some users may have habits/routines that prevent them from engaging in wireless network activity until much later in the evening. All of this data is available to and considered by the network 212.

The network 212, in its calculations, can predict how long it will take to perform specific downloads. This can be based on the location of the cell site, the location of the user, the location of the CPE 214, and the like. For instance, a user that is closer to the base station (e.g., tower 110) will experience a stronger connection than a user that is at cell edge. Thus, the user that is closer to the base station will be able to download the same content at a faster rate than the user that is at cell edge. With respect to CPEs, a FWA is not typically mobile so the location of the FWA will remain static, but still be considered by the network 212 to assess a link strength to the network 212. Thus, the network 212 can determine a time a download should happen and how long it will take, based on network and user data. These predictions can occur every 24 hours, or at any other appropriate time interval.

Step 220 illustrates a registration process between the CPE 214 and a content server 210. The registration information sent from the CPE 214 can include an IP address of the CPE 214, a location of the CPE 214, a storage capacity of the CPE 214, an available storage capacity of the CPE 214, and the like. The registration information can also include the window of time available to pre-cache content to the CPE 214, as determined by the network 212 and communicated to the CPE 214. As mentioned, the window of time available to pre-cache is based on network system capacity for a cell site associate with the CPE 214.

As step 222, the user device (either 214a or 214b) requests registration of a content provider application on their device with the content server 210. A response to that request is sent from the content server 210 to the device 216a at step 224. Once client's register an application, a mapping of client devices (having the content application thereon) to CPEs is created at block 226. The mapping maps client devices to a CPE by comparing locations of each of the devices and a location of the CPE. The CPE is associated with all connected devices having the same location as the CPE and having established connectivity to a content server through the CPE and a map is created that illustrates the association. The mapping can be used with a prediction algorithm (e.g., predicting content to cache, predicting a window of time to cache, etc.) to optimize the process. Once mapped, the content server 210 predicts content at block 228 to be provided to the client device. This prediction identifies content to be delivered based on historical viewing. The prediction can also clean up a present cache by deleting content that has been previously viewed, deleting content that no longer is predicted as relevant to a user, maintaining un-viewed content that is still predicted as relevant to a user, and identifying content to add to the cache, depending on available storage capacity of the CPE. This prediction is performed to predict content for a user and store it locally on the CPE. This prediction also utilizes wireless network parameters from the network 212.

The predictions described herein (e.g., what content to provide, when to provide it, windows of time available to download content off-peak, etc.) can occur at any predefined time interval. In embodiments, the predictions occur every 24 hours. Storage is limited at storage devices, such as CPE 214, so performance of the prediction algorithm every 24 hours is needed to monitor the storage capacity. Alternatively, the prediction algorithm could also be run on peak hour user content viewing (e.g., 17:00-21:00). For example, assume that at a first point in time, a user is pushed (via pre-caching) content A, content B, content C, and content D. At a second point in time (after the first point in time), the user has viewed content A and content B, but not content C or content D. At this point, content A and content B would be deleted, as they have already been consumed by the user and are taking up storage space. Assuming a prediction for content C and content D is still high, they will remain in storage for later consumption by the user. Additionally, storage was made available by deleting content A and content B, so any other content predicted to be of interest to a user can be added.

Using the predictions of content by the content server 210 and the predictions on network capacity by the network 212, content can be downloaded at step 230 and locally stored at block 232 at the CPE 214. Next, the user selects the content at block 234. An authentication/key exchange is communicated at step 236 and a request for the content location (URL) is sent at step 238. The content server 210 is aware of the location of the content. In the event the content requested was not predicted cache content, a remote URL is provided to the user device for real-time viewing. In the event the content requested was predicted cache content, the content server 210 is aware of the location of the pre-cached content at the CPE 214. In that case, the content server 210 can provide a local URL for the locally cached content to the device 216a at step 240. The device 216a can then get the requested content directly from the local storage of the CPE 214 at step 242. The content is played back at block 244 on the user device 216a.

By accessing the content locally, there is no data sent on the network. It was pre-cached in an optimal download environment (e.g., off-peak hours) so it is available with a higher resolution and higher accuracy than real-time downloading/viewing during peak hours may be provided. The user is not impacted by any network congestion at the time of viewing since the content is already locally cached and available.

The above-described call flow 200 is a representation of some aspects of the invention. Additional details may be included such as providing network requirements to the content server 210 for use in the prediction algorithm. For instance, the network 212 can provide the content server 210 with a threshold prediction accuracy level, a bit rate, a time available, and storage available, via the CPE 214. The content server 210 would have to meet these parameters in order to pre-cache content. If not, real-time viewing is still available to the user such as in the instance where a user rarely streams content and predictions are not highly accurate; that user may be subject to real-time viewing of content since predictions are inaccurate and pre-cache of data is not likely to be used.

As an example, assume that the network 212 determines that a 10% prediction accuracy is required for pre-cache of data based on the particular network capacity and resources, storage available at the CPE 214, and the like. The network 212 also determines that the window of time available for pre-cache of data, based on the network capacity, is 2 am-4 am. The network 212 can identify and provide the bandwidth available during the window of time available for downloading the content. The content server 210 can use the network constraints (i.e., the prediction accuracy, the window of time available, the available bandwidth, etc.) to determine if the content predicted for the user can be pre-cached. For instance, if the content server 210 has a 50% prediction accuracy for a user then the prediction accuracy threshold of at least 10% is met. If the content server 210 has 10 hours' worth of content that, based on the available bandwidth will take 30 minutes to download, the content server 210 can meet the window of time constraint since two hours was provided (2 am-4 am). However, if the content server 210 were evaluating a user where there is a 5% prediction accuracy, pre-cache of data would not be available for that user since the network constraints are not satisfied. Similarly, if a content server 210 had predicted content that would take 3 hours to download, the window of time constraint of two hours would not be met and that predicted content would not be pre-cached.

As noted above, the network constraints may vary since network capacity varies for each cell site. As previously described, the network 212 knows the historical performance of the cell tower (e.g., load) so it can identify busy times/peak hours. The network 212 can predict what the tower will look like in 24 hours based on its historical performance. The locations of relevant devices (e.g., CPEs, UEs, etc.) is also known (and many are fixed) so the quality of the radio link/connection is known. This data makes it possible for the network 212 to predict the time needed to download content. The necessary download times are custom to each user's location (e.g., closer to tower has a stronger connection and a faster download rate). Also custom to a user, the network 212 is aware of each user's rate of throughput (e.g., User A always watches Netflix when he gets home for hours at a time vs. User B who streams content once a week).

Embodiments described herein can initiate this process at a predetermined time interval (e.g., the network evaluates/predicts network conditions every 24 hours). Alternatively, the process described herein could be triggered to initiate when a period of congestion is identified. This period of congestion may be outside of peak hours such that it normally would not be a concern. Further, the process herein could be triggered when a user opens the content application on their UE. The network 212 would be aware of the content application being opened and the content server 210 can query the network as to whether or not content should be downloaded or viewed in real-time. During a high congestion time or peak hours, downloading may be restricted by the network 212 and real-time viewing is the directive given to the content server 210. However, in off-peak hours, even if outside of the predicted window of time for pre-caching, the network 212 may indicate that conditions are satisfactory for a download of content rather than real-time viewing. Thus, congestion time periods may restrict all download requests while time periods that are not experiencing high congestion may be prime for downloading content rather than real-time viewing.

The present disclosure provides benefits to networks, content providers, and users. The network is able to efficiently manage network resources such that peak traffic can be transferred to non-peak hours to eliminate some congestion during peak hours. This allows the network to operate more efficiently. The user experience is also enhanced since they can be provided with the highest resolution and highest accuracy content during peak times due to the off-peak caching of the content.

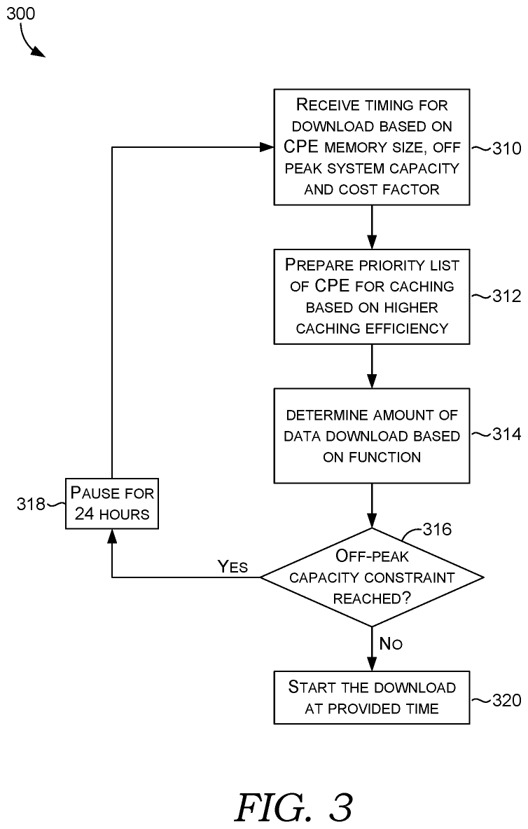

Turning now to FIG. 3, a flow diagram 300 is provided illustrated a flow to intelligently cache content. Specifically, FIG. 3 illustrates a flow diagram 300 explaining the predictive algorithm to determine timing and amount of downloads for a predetermined time period. The volume of data downloaded to the CPE can be computed as a function of the following:

V=volume of video watched per day by a user

F=Free Off-peak system capacity

OPC=Off-peak bit cost factor

CPEM=CPE Memory Size Capacity

The free off-peak system capacity is a maximum available system capacity at off-peak hours when a download can occur. Off-peak bit cost factor is a difference in cost of sending data between peak and off-peak hours. CPE Memory size capacity is a size of CPE memory allocated to video caching. The volume of data downloaded is calculated as follows:

Volume Downloaded=f(V, F, OPC, CPEM).

Initially, at block 310, a window of time for downloading is received based on CPE memory/storage size, off-peak system capacity, and a cost factor to the system. A priority list of CPEs for caching is created at block 312 based on higher caching efficiency. Higher caching efficiency, as used herein, refers generally to the ability to pre-cache content to the CPE in less time than other CPEs or at a lower cost. At block 314, the amount of data downloaded is determined based on the function provided above (f(V, F, OPC, CPEM)). If the off-peak capacity constraint is reached at block 316, the processes is paused for 24 hours at block 318 and then begins again at block 310. If the off-peak capacity constraint is not reached, the downloaded can begin at the provided time at block 320. The method will then continue on for each CPE in the list of prioritized CPEs (e.g., starting at block 314 through 320).

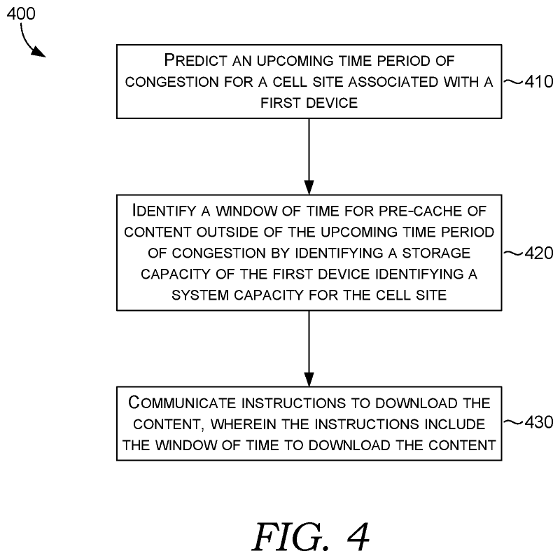

Turning to FIG. 4, a flow diagram 400 is provided illustrating a flow to intelligently cache content. Initially, at block 410, an upcoming time period of congestion for a cell site associated with a first device is predicted. This may be peak hours for the cell site. At block 420, a window of time for pre-cache of content outside of the upcoming time period of congestion is identified. The window of time for pre-cache of content is identified by identifying a storage capacity of the first device and identifying a system capacity for the cell site. At block 430, instructions to download the content are communicated. The instructions include the window of time to download the content.

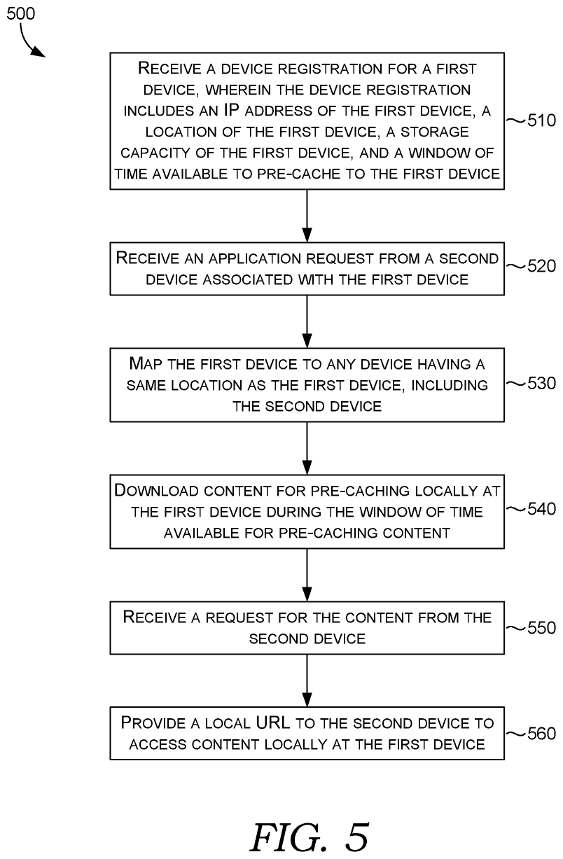

Referring to FIG. 5, a flow diagram 500 is provided illustrating a flow to intelligently cache content. At block 510, a device registration for a first device is received. The device registration includes an IP address of the first device, a location of the first device, a storage capacity of the first device, and a window of time available to pre-cache to the first device. The window of time available to pre-cache to the first device is based on network system capacity for a cell site associated with the first device. At block 520, an application request is received from a second device associated with the first device, where the application request includes at least a location of the second device. At block 530, the first device is mapped to any device having a same location as the first device, including the second device that established connectivity to a content server through the first device. At block 540, content is downloaded for pre-caching locally at the first device during the window of time available for pre-caching content. At block 550, a request for the content is received from the second device and a local URL is provided to the second device to access content locally at the first device at block 560.

Referring to FIG. 6, a block diagram of an exemplary computing device 600 suitable for use in implementations of the technology described herein is provided. In particular, the exemplary computer environment is shown and designated generally as computing device 600. Computing device 600 is but one example of a suitable computing environment and is not intended to suggest any limitation as to the scope of use or functionality of the invention. Neither should computing device 600 be interpreted as having any dependency or requirement relating to any one or combination of components illustrated. It should be noted that although some components in FIG. 6 are shown in the singular, they may be plural. For example, the computing device 600 might include multiple processors or multiple radios. In aspects, the computing device 600 may be a UE/WCD, or other user device, capable of two-way wireless communications with an access point. Some non-limiting examples of the computing device 600 include a cell phone, tablet, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

As shown in FIG. 6, computing device 600 includes a bus 610 that directly or indirectly couples various components together, including memory 612, processor(s) 614, presentation component(s) 616 (if applicable), radio(s) 624, input/output (I/O) port(s) 618, input/output (I/O) component(s) 620, and power supply(s) 622. Although the components of FIG. 6 are shown with lines for the sake of clarity, in reality, delineating various components is not so clear, and metaphorically, the lines would more accurately be grey and fuzzy. For example, one may consider a presentation component such as a display device to be one of I/O components 620. Also, processors, such as one or more processors 614, have memory. The present disclosure hereof recognizes that such is the nature of the art, and reiterates that FIG. 6 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 612 may take the form of memory components described herein. Thus, further elaboration will not be provided here, but it should be noted that memory 612 may include any type of tangible medium that is capable of storing information, such as a database. A database may be any collection of records, data, and/or information. In one embodiment, memory 612 may include a set of embodied computer-executable instructions that, when executed, facilitate various functions or elements disclosed herein. These embodied instructions will variously be referred to as “instructions” or an “application” for short.

Processor 614 may actually be multiple processors that receive instructions and process them accordingly. Presentation component 616 may include a display, a speaker, and/or other components that may present information (e.g., a display, a screen, a lamp (LED), a graphical user interface (GUI), and/or even lighted keyboards) through visual, auditory, and/or other tactile cues.

Radio 624 represents a radio that facilitates communication with a wireless telecommunications network. Illustrative wireless telecommunications technologies include CDMA, GPRS, TDMA, GSM, and the like. Radio 624 might additionally or alternatively facilitate other types of wireless communications including Wi-Fi, WiMAX, LTE, 3G, 4G, LTE, mMIMO/5G, NR, VOLTE, or other VoIP communications. As can be appreciated, in various embodiments, radio 624 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

The input/output (I/O) ports 618 may take a variety of forms. Exemplary I/O ports may include a USB jack, a stereo jack, an infrared port, a firewire port, other proprietary communications ports, and the like. Input/output (I/O) components 620 may comprise keyboards, microphones, speakers, touchscreens, and/or any other item usable to directly or indirectly input data into the computing device 600.

Power supply 622 may include batteries, fuel cells, and/or any other component that may act as a power source to supply power to the computing device 600 or to other network components, including through one or more electrical connections or couplings. Power supply 622 may be configured to selectively supply power to different components independently and/or concurrently.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

What is claimed is:

1. A system for intelligently caching content, the system comprising:
one or more processors; and
one or more computer-readable media storing computer-usable instructions that, when executed by the one or more processors, cause the one or more processors to:
predict an upcoming time period of congestion for a cell site associated with a first device;
identify a window of time for pre-cache of content outside of the upcoming time period of congestion, wherein identifying the window of time for pre-cache of content includes:
identifying a storage capacity of the first device; and
identifying a system capacity for the cell site; and
communicate instructions to download the content, wherein the instructions include the window of time to download the content.

2. The system of claim 1, wherein the window of time for pre-cache of content includes a start time and a stop time.

3. The system of claim 1, wherein the first device is customer premises equipment (CPE).

4. The system of claim 3, wherein the first device is a fixed wireless access device.

5. The system of claim 1, wherein the first device is a mobile smartphone.

6. The system of claim 1, wherein the instructions to download the content includes a rate, a size, and a speed of the download.

7. The system of claim 1, wherein predicting the upcoming time period of congestion for a cell site further comprises identifying a quality of a radio link between the cell site and the first device.

8. The system of claim 7, wherein based on the quality of the radio link between the cell site and the first device, the processors are further configured to identify an estimated time needed for a download.

9. A method for intelligently caching content, the method comprising:
predicting an upcoming time period of congestion for a cell site associated with a first device;
identifying a window of time for pre-cache of content outside of the upcoming time period of congestion, wherein identifying the window of time for pre-cache of content includes:
identifying a storage capacity of the first device; and
identifying a system capacity for the cell site; and
communicating instructions to download the content, wherein the instructions include the window of time to download the content.

10. The method of claim 9, wherein the window of time for pre-cache of content includes a start time and a stop time.

11. The method of claim 9, wherein the first device is customer premises equipment (CPE).

12. The method of claim 11, wherein the first device is a fixed wireless access device.

13. The method of claim 9, wherein the instructions to download the content includes a rate, a size, and a speed of the download.

14. The method of claim 9, wherein the processors are further configured to identify a quality of a radio link between the cell site and the first device.

15. The method of claim 14, wherein the processors are further configured to, based on the quality of the radio link between the cell site and the first device, identify an estimated time needed for a download.

16. A system for intelligently caching content, the system comprising:
one or more processors; and
one or more computer-readable media storing computer-usable instructions that, when executed by the one or more processors, cause the one or more processors to:
receive a device registration for a first device, wherein the device registration includes an IP address of the first device, a location of the first device, a storage capacity of the first device, and a window of time available to pre-cache to the first device, wherein the window of time available to pre-cache to the first device is based on network system capacity for a cell site associated with the first device;
receive an application request from a second device associated with the first device, where the application request includes at least a location of the second device;
map the first device to any device having a same location as the first device, including the second device;
download content for pre-caching locally at the first device during the window of time available for pre-caching content;
receive a request for the content from the second device; and
provide a local URL to the second device to access content locally at the first device.

17. The system of claim 16, wherein the window of time available to pre-cache to the first device is outside of an upcoming time period of congestion for a cell site associated with the first device.

18. The system of claim 16, wherein the one or more processors is further configured to receive network parameters to satisfy prior to downloading content, wherein the network parameters includes a prediction accuracy level.

19. The system of claim 18, wherein the content is downloaded when the prediction accuracy level meets or exceeds a predetermined threshold.

20. The system of claim 16, wherein the local URL is available to any device mapped to the first device.
